(19) United States
(12) Patent Application Publication
(10) Pub. No.: US 2026/0133090 A1
(43) Pub. Date: May 14, 2026

(54) DEVICE FOR DETECTING AND ADJUSTING COMPREHENSIVE DYNAMIC BALANCE OF TURBOMOLECULAR PUMP ROTORS

(71) Applicant: BEIHANG UNIVERSITY, Beijing (CN)

(72) Inventors: Kun WANG, Beijing (CN); Shiqiang ZHENG, Beijing (CN); Hao LI, Beijing (CN)

(73) Assignee: BEIHANG UNIVERSITY, Beijing (CN)

(21) Appl. No.: 19/075,482

(22) Filed: Mar. 10, 2025

Related U.S. Application Data
(63) Continuation of application No. PCT/CN2025/070766, filed on Jan. 6, 2025.

(30) Foreign Application Priority Data
Nov. 8, 2024 (CN) 2024115878671

(51) Int. Cl. G01M 1/22; G01M 1/32

(52) U.S. Cl. CPC G01M 1/22; G01M 1/32

(57) ABSTRACT

A device for detecting and adjusting comprehensive dynamic balance of turbomolecular pump rotors is provided. The device includes a test platform; a supporting mechanism arranged in the test platform, a detection mechanism arranged in the test platform and configured for detecting a dynamic balance of the turbine rotor to be tested in a rotating process, a driving mechanism arranged at a bottom of the test platform and configured for driving the turbine rotor to be tested to rotate, and a weight removing mechanism arranged at the top of a test platform and configured for reducing a weight of the traction tube. A front end of a turbine rotor to be tested is in transmission connection with the supporting mechanism through a connecting block, and a traction tube at a rear end of the turbine rotor to be tested is in transmission connection with the supporting mechanism.

### CROSS-REFERENCE TO RELATED APPLICATIONS

This application is a continuation of PCT/CN2025/070766, filed on Jan. 6, 2025, and claims priority to Chinese Patent Application No. 202411587867.1, filed on Nov. 8, 2024, the contents of which are incorporated herein by reference.

### TECHNICAL FIELD

The present disclosure relates to the technical field of dynamic balance of turbomolecular pump rotors, and in particular to a device for detecting and adjusting comprehensive dynamic balance of turbomolecular pump rotors.

### BACKGROUND

A molecular pump is vacuum obtaining equipment, and its working principle is that the linear speed of blades reaches the thermal motion speed of molecules through high-speed rotation, and the gas obtains a directional velocity through momentum exchange with the blades and is then discharged from the cavity. Magnetic levitation turbomolecular pump is widely applied in various industries because of its advantages such as being oil-free, wear-free, having low noise, and being installable at any angle, etc., and its rotating speed is generally high during operation. The vibration caused by the unbalance of the rotors can directly affect the molecular pump, so it is can be important to ensure dynamic balance of the rotors in advance, and the dynamic balance accuracy needs to reach G0.4 or above. To perform dynamic balance on the rotor, it is can be carried out offline dynamic balancing on the dynamic balancing machine first, and then the rotor is assembled onto the molecular pump, so as to perform online dynamic balancing with a high-precision dynamic balancing instrument.

During offline dynamic balancing, the rotating speed of the dynamic balancing machine is usually within 3000 revolutions, so the dynamic balancing amount is controlled within a certain range first. The rotor includes a rotating shaft and an impeller, and offline dynamic balance requires the rotating shaft and impeller to be dynamically balanced separately. When performing the dynamic balancing on the impeller, it can be connected to the standard shaft before performing dynamic balancing, if the required dynamic balance level is not achieved, it can be removed and processed to remove the weight until the required dynamic balance level is met.

In the existing technical solutions, the rotating shaft and the impeller of the rotor are dynamicly balanced separately. During the dynamic balancing process, the rotating shaft and the impeller are repeatedly removed from the dynamic balancing machine for machining, so as to reduce weight. This technical solution is inefficient and complicated to operate, and at the same time, even if the dynamic balance is performed well, errors will still occur when assembling the rotating shaft and the impeller, which is not conducive to the mass production of molecular pumps.

### SUMMARY

The objective of the present disclosure is to provide a device for detecting and adjusting comprehensive dynamic balance of turbomolecular pump rotors, so as to solve the problems existing in the prior art.

In order to achieve the above objective, the disclosure provides the following solution: the present disclosure provides a device for detecting and adjusting comprehensive dynamic balance of turbomolecular pump rotors, including:
a test platform;
a supporting mechanism arranged in the test platform, where a front end of a turbine rotor to be tested is in transmission connection with the supporting mechanism through a connecting block, and a traction tube at a rear end of the turbine rotor to be tested is in transmission connection with the supporting mechanism;
a detection mechanism arranged in the test platform and configured for detecting a dynamic balance of the turbine rotor to be tested in a rotating process;
a driving mechanism arranged at a bottom of the test platform and configured for driving the turbine rotor to be tested to rotate; and
a weight removing mechanism arranged at a top of the test platform and configured for reducing a weight of the traction tube.

In some embodiments, the supporting mechanism includes outer frames symmetrically and fixedly connected to a bottom surface of the test platform, a top of a spring leaf is fixedly connected in each of the outer frames, the bottom of the spring leaf is fixedly connected to an inner frame, a pressure plate is arranged in the inner frame, one end of the pressure plate close to the connecting block is provided with a first support component, the first support component is in transmission connection with the connecting block, and another end of the pressure plate close to the traction tube is provided with a second support component, the second support component is in transmission connection with the traction tube, a bottom of the inner frame is in threaded connection with an adjusting screw, and the adjusting screw is abuts against each of the first support component and the second support component.

In some embodiments, the first support component includes a first adjusting plate fixedly connected between the inner frame and the pressure plate, and a top of the first adjusting plate is provided with a first groove, the first groove is located below the connecting block, and first driven pulleys are symmetrically installed on both sides of the first groove, the first driven pulleys are matched with the connecting block, and the first adjusting plate abuts against a top surface of the adjusting screw.

In some embodiments, the second support component includes a second adjusting plate fixedly connected between the inner frame and the pressure plate, and a top surface of the second adjusting plate is provided with a second groove, the second groove is located below the traction tube, and second driven pulleys are symmetrically installed on two sides of the second groove, and the second driven pulleys are matched with the traction tube.

In some embodiments, two sides of the supporting mechanism are respectively provided with fixing mechanisms, each of the fixing mechanisms includes a first support rod fixedly connected to the inner bottom surface of the test platform; a top surface of the first support rod is provided with a grooved connecting plate; a compression nut is slidably connected inside the grooved connecting plate; the compression nut is in threaded connection with the top surface of the first support rod; and one end of the grooved connecting plate from the first support rod is rotatably connected to a corresponding one of rotating wheels, where one of the rotating wheels abuts against the connecting block, another of the rotating wheels abuts against the shaft end nut close to the traction tube.

In some embodiments, the detection mechanism includes a laser detection part fixedly connected in the test platform and vibration detection parts symmetrically arranged at two sides of the supporting mechanism, where the laser detection part includes a second support rod fixedly connected to the test platform, and the second support rod is located at one side close to the traction tube; a top surface of the second support rod is connected to a third support rod through a first universal ball joint; and a top surface of the third support rod is connected to a clamping component through a second universal ball joint, and the clamping component is internally provided with a laser speed sensor.

In some embodiments, each of the vibration detection parts includes brackets arranged outside the outer frames, a metal thin rod is fixedly connected to each of the brackets, a vibration sensor is arranged on the metal thin rod, and the vibration sensor is fixedly connected to the bottom surface of the test platform.

In some embodiments, the weight removing mechanism includes a mobile platform installed at a top of the test platform, a tool holder is installed on the mobile platform, a cutting tool is installed in the tool holder, and the cutting tool is located above the traction tube.

In some embodiments, the driving mechanism includes a drive box fixedly connected to the bottom of the test platform, a drive motor is installed on one side of the drive box, an output shaft of the drive motor extends into the drive box and is installed with a first gear shaft through a coupling, the first gear shaft is rotatably connected to the drive box, a first gear and a second gear are both fixedly connected to the first gear shaft, a second gear shaft is rotatably connected in the drive box, a third gear and a fourth gear are both fixedly connected to the second gear shaft, the first gear is matched with the third gear, the second gear is matched with the fourth gear, a belt pulley is fixedly connected to the second gear shaft, and the belt pulley is in transmission connection with the traction tube through a belt.

The following technical effects of the disclosure are as follows. The turbine rotor that requires dynamic balance is connected to the connecting block through bolts, then the turbine rotor is installed on the supporting mechanism, the driving mechanism is connected to the traction tube, then the position of the detection mechanism is adjusted. The driving mechanism is started, firstly the dynamic balance is carried out at a gear ratio of 1:1, and then the weight removing device is started to remove the weight of the traction tube. Then the dynamic balance amount at a high rotational speed with a gear ratio of 1:4 is measured. The steps of weight removing detection is repeated until the dynamic balance meets the requirements.

By adding the connecting block at the end of the rotor, the rotating shaft and the turbine rotor are dynamically balanced together, which replaces the traditional dynamic balancing method that requires the rotating shaft and the turbine rotor being dynamically balanced separately, and integrates the weight removing mechanism with the dynamic balance device, thus achieving the purpose of removing the weight without removing the rotor from the machine. This substitutes the previous approach where, after obtaining the unbalance amount, the rotor had to be removed from the machine for weight-removal operation and then the dynamic balance was verified. The present disclosure is conducive to improving the efficiency during mass production and reducing costs.

### BRIEF DESCRIPTION OF THE DRAWINGS

The accompanying drawings, which constitute a part of the disclosure, are used to provide a further understanding of the disclosure. The illustrative embodiments of the disclosure and descriptions are used to explain the disclosure, and do not constitute an improper limitation of the disclosure. In the attached drawings:

FIG. 1 is a structural schematic diagram of a device for detecting and adjusting comprehensive dynamic balance of turbomolecular pump rotors according to the disclosure;

FIG. 2 is a partial enlarged view of portion A in FIG. 1.

FIG. 3 is a front view of the device for detecting and adjusting comprehensive dynamic balance of turbomolecular pump rotors of the disclosure.

FIG. 4 is a right-side view of the device for detecting and adjusting comprehensive dynamic balance of turbomolecular pump rotors of the disclosure.

### DETAILED DESCRIPTION OF THE EMBODIMENTS

In the following, the technical solutions in the embodiments of the present disclosure will be clearly and completely described with reference to the attached drawings. Apparently, the described embodiments are only a part of the embodiments of the present disclosure, but not all the embodiments. Based on the embodiments in the present disclosure, all other embodiments obtained by one of ordinary skill in the art without creative effort belong to the protection scope of the present disclosure.

In order to make the above objectives, features and advantages of the present disclosure clearer and easier to understand, the present disclosure will be further described in detail with the attached drawings and specific embodiments.

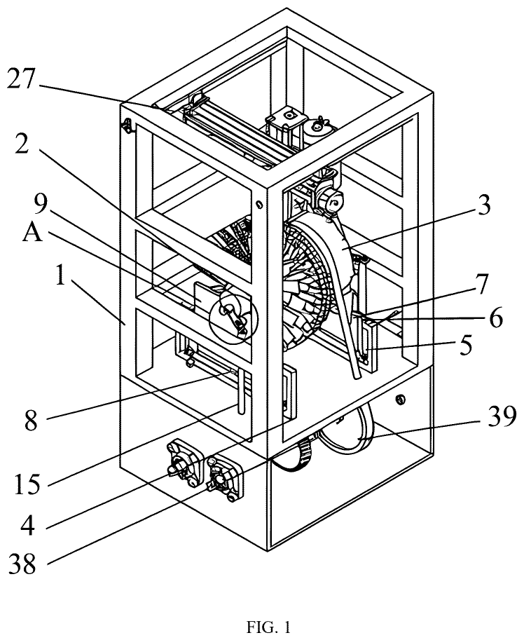

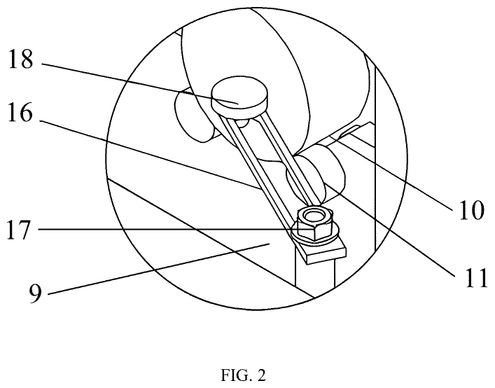

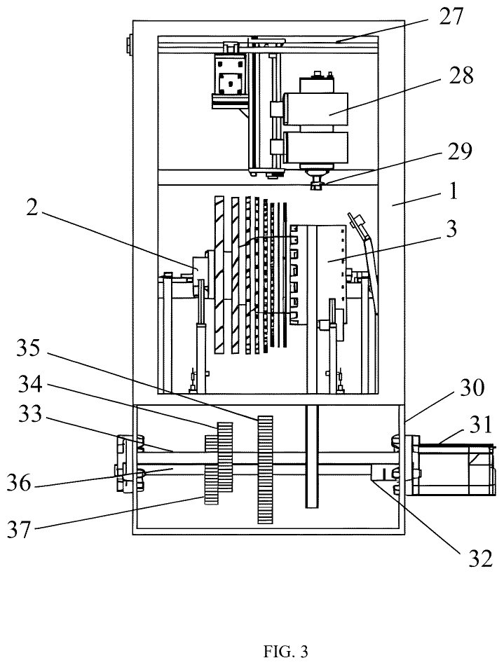

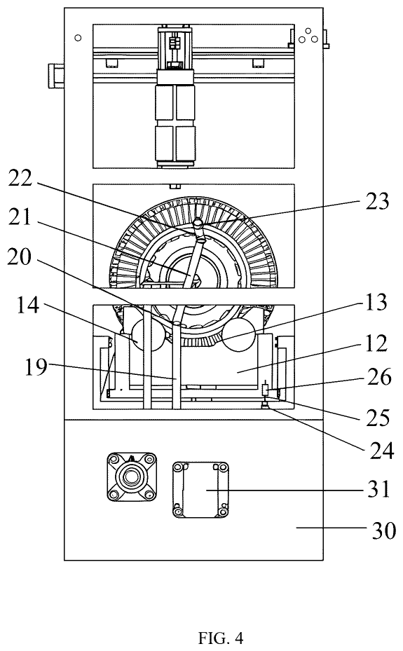

Referring to FIG. 1 to FIG. 4, this embodiment provides a device for detecting and adjusting comprehensive dynamic balance of turbomolecular pump rotors, and the device includes a test platform 1, a supporting mechanism, a detection mechanism, a driving mechanism, and a weight removing mechanism.

The supporting mechanism is arranged in the test platform 1, a front end of a turbine rotor to be tested is in transmission connection with the supporting mechanism through a connecting block 2, and a traction tube 3 at a rear end of the turbine rotor to be tested is in transmission connection with the supporting mechanism.

The detection mechanism is arranged in the test platform 1 and used for detecting a dynamic balance of the turbine rotor to be tested in the rotating process.

The driving mechanism is arranged at a bottom of the test platform 1 and used for driving the turbine rotor to be tested to rotate.

The weight removing mechanism is arranged at a top of the test platform 1 and used for reducing a weight of the traction tube 3.

The turbine rotor that needs to be dynamically balanced and the connecting block 2 are connected by bolts, and then they are mounted on the support mechanism, and the driving mechanism is connected to the traction tube 3, and then a position and retrograde adjustment of the detecting mechanism are performed, and the driving mechanism is started. The dynamic balance is carried out at a gear ratio of 1:1 first, and after obtaining the amount of unbalance, the weight removing mechanism is started to remove the weight of the traction tube 3. And the amount of dynamic balance at the high rotational speed with the gear ratio of 1:4 is then measured, and the steps of weight removing detection is repeated until the dynamic balance meets the requirements.

By adding the connecting block 2 at the end of the rotor, the rotating shaft and the turbine rotor are dynamically balanced together, which replaces traditional dynamic balancing method that requires the rotating shaft and the turbine rotor to be dynamically balanced separately, and integrates the weight removing mechanism and the dynamic balance device together, thus achieving a purpose of removing the weight without removing the rotor from the machine. This substitutes the previous approach where, after obtaining the unbalance amount, the rotor had to be removed from the machine for weight-removal operation and then the dynamic balance was verified. The present disclosure is conducive to improving the efficiency during mass production and reducing costs.

In a further embodiment, the supporting mechanism includes outer frames 4 symmetrically and fixedly connected to a bottom surface of the test platform 1. A top of a spring leaf 5 is fixedly connected in the outer frame 4, a bottom of the spring leaf 5 is fixedly connected to an inner frame 6, a pressure plate 7 is arranged in the inner frame 6, one end of the pressure plate 7 close to the connecting block 2 is provided with a first support component, the first support component is in transmission connection with the connecting block 2, and the other end of the pressure plate 7 close to the traction tube 3 is provided with a second support component which is in transmission connection with the traction tube 3, the bottom of the inner frame 6 is threadedly connected to an adjusting screw 8. The adjusting screws 8 abuts against the first support component and the second support component respectively.

In a further embodiment, the first support component includes a first adjusting plate 9 fixedly connected between the inner frame 6 and the pressure plate 7, and a top of the first adjusting plate 9 is provided with a first groove 10, the first groove 10 is located below the connecting block 2, and first driven pulleys 11 are symmetrically installed on two sides of the first groove 10, the first driven pulleys 11 are matched with the connecting block 2, and the first adjusting plate 9 abuts against a top surface of the adjusting screw 8.

In a further embodiment, the second support component includes a second adjusting plate 12 fixedly connected between the inner frame 6 and the pressure plate 7, and a top surface of the second adjusting plate 12 is provided with a second groove 13, the second groove 13 is located below the traction tube 3, and second driven pulleys 14 are symmetrically installed on two sides of the second groove 13, and the second driven pulleys 14 are matched with the traction tube 3.

Heights of the first adjusting plate 9 and the second adjusting plate 12 are adjusted by the adjusting screws 8, so that the turbine rotor is kept horizontal during the rotation. The two first driven pulleys 11 are respectively located at both sides of the connecting block 2, and the two second driven pulleys 14 are respectively located at both sides of the traction tube 3.

In a further embodiment, two sides of the supporting mechanism are respectively provided with fixing mechanisms. The fixing mechanism includes a first support rod 15 fixedly connected to an inner bottom surface of the test platform 1; a grooved connecting plate 16 is arranged on a top surface of the first support rod 15; a compression nut 17 is slidably connected inside the grooved connecting plate 16; the compression nut 17 is in threaded connection with the top surface of the first support rod 15; and one end of the grooved connecting plate 16 from the first support rod 15 is rotatably connected to a rotating wheel 18. One of the rotating wheels 18 abuts against the connecting block 2, and another rotating wheel 18 abuts against the shaft end nut near the traction tube 3.

In a further embodiment, the detection mechanism includes a laser detection part fixedly connected in the test platform 1 and vibration detection parts symmetrically arranged at two sides of the supporting mechanism, where the laser detection part includes a second support rod 19 fixedly connected to the test platform 1, and the second support rod 19 is located at one side close to the traction tube 3; the top surface of the second support rod 19 is connected to a third support rod 21 through a first universal ball joint 20; and the top surface of the third support rod 21 is connected to a clamping component 22 through a second universal ball joint, and a laser speed sensor 23 is installed in the clamping component 22.

In a further embodiment, the vibration detection part includes a bracket 26 arranged outside the outer frame 4, and a thin metal rod 25 is fixedly connected to the bracket 26, and a vibration sensor 24 is arranged on the thin metal rod 25, and the vibration sensor 24 is fixedly connected to the bottom surface of the test platform 1.

When rotating, the spring leaf 5 in the fixing mechanism vibrates due to dynamic unbalance, and a vibration is transmitted to the vibration sensor 24 through the thin metal rod 25, so that a vibration signal is processed to measure the unbalance amount and weight removal position.

In a further optimization scheme, the weight removing mechanism includes a mobile platform 27 installed at the top of the test platform 1, and a tool holder 28 is installed on the mobile platform 27, and a cutting tool 29 is installed in the tool holder 28, and the cutting tool 29 is located above the traction tube 3.

The cutting tool 29 is mainly used to remove the weight from the outer wall of the traction tube 3 of the turbine rotor after calculating the weight removal position and weight. The operation of the cutting tool 29 is realized by a machine tool.

In a further embodiment, the driving mechanism includes a drive box 30 fixedly connected to the bottom of the test platform 1, a drive motor 31 is installed on one side of the drive box 30, the output shaft of the drive motor 31 extends into the drive box 30 and a first gear shaft 33 is installed on it through a coupling 32, the first gear shaft 33 is rotatably connected to the drive box 30, a first gear 34 and a second gear 35 are both fixedly connected to the first gear shaft 33, and a second gear shaft 36 is also rotatably connected in the drive box 30, a third gear 37 and a fourth gear 38 are both fixedly connected to the second gear shaft 36, the first gear 34 is matched with the third gear 37, and the second gear 35 is matched with the fourth gear 38; a belt pulley 39 is fixedly connected to the second gear shaft 36, and the belt pulley 39 is in transmission connection with the traction tube 3 through a belt.

In the description of the present disclosure, it should be understood that the terms “longitudinal”, “transverse”, “up”, “down”, “front”, “back”, “left”, “right”, “vertical”, “horizontal”, “top”, “bottom”, “inside”, “outside”, etc. indicate orientation or positional relationships based on the orientation or positional relationships shown in the accompanying drawings, only for the convenience of describing the present disclosure, and do not indicate or imply that the device or element referred to must have a specific orientation, be constructed and operated in a specific orientation, and therefore cannot be understood as a limitation of the present disclosure.

The above-mentioned embodiments only describe the preferred mode of the present disclosure, and do not limit the scope of the present disclosure. Under the premise of not departing from the design spirit of the present disclosure, various modifications and improvements made by one of ordinary skill in the art to the technical solution of the present disclosure should fall within the protection scope of the present disclosure.

What is claimed is:

1. A device for detecting and adjusting comprehensive dynamic balance of turbomolecular pump rotors, comprising:
a test platform;
a supporting mechanism arranged in the test platform, wherein a front end of a turbine rotor to be tested is in transmission connection with the supporting mechanism through a connecting block, and a traction tube at a rear end of the turbine rotor to be tested is in transmission connection with the supporting mechanism;
a detection mechanism arranged in the test platform and configured for detecting a dynamic balance of the turbine rotor to be tested in a rotating process;
a driving mechanism arranged at a bottom of the test platform and configured for driving the turbine rotor to be tested to rotate; and
a weight removing mechanism arranged at a top of the test platform and configured for reducing a weight of the traction tube.

2. The device for detecting and adjusting comprehensive dynamic balance of turbomolecular pump rotors according to claim 1, wherein the supporting mechanism comprises outer frames symmetrically and fixedly connected to a bottom surface of the test platform, a top of a spring leaf is fixedly connected in each of the outer frames, a bottom of the spring leaf is fixedly connected to an inner frame, a pressure plate is arranged in the inner frame, one end of the pressure plate close to the connecting block is provided with a first support component, the first support component is in transmission connection with the connecting block, another end of the pressure plate close to the traction tube is provided with a second support component, the second support component is in transmission connection with the traction tube, a bottom of the inner frame is in threaded connection with an adjusting screw, and the adjusting screw abuts against each of the first support component and the second support component.

3. The device for detecting and adjusting comprehensive dynamic balance of turbomolecular pump rotors according to claim 2, wherein the first support component comprises a first adjusting plate fixedly connected between the inner frame and the pressure plate, a top of the first adjusting plate is provided with a first groove, the first groove is located below the connecting block, first driven pulleys are symmetrically installed on two sides of the first groove, the first driven pulleys are matched with the connecting block, and the first adjusting plate abuts against a top surface of the adjusting screw.

4. The device for detecting and adjusting comprehensive dynamic balance of turbomolecular pump rotors according to claim 2, wherein the second support component comprises a second adjusting plate fixedly connected between the inner frame and the pressure plate, a top surface of the second adjusting plate is provided with a second groove, the second groove is located below the traction tube, second driven pulleys are symmetrically installed on two sides of the second groove, and the second driven pulleys are matched with the traction tube.

5. The device for detecting and adjusting comprehensive dynamic balance of turbomolecular pump rotors according to claim 1, wherein two sides of the supporting mechanism are respectively provided with fixing mechanisms, and each of the fixing mechanisms comprises a first support rod fixedly connected to an inner bottom surface of the test platform, a top surface of the first support rod is provided with a grooved connecting plate, a compression nut is slidably connected inside the grooved connecting plate, the compression nut is in threaded connection with the top surface of the first support rod; one end, away from the first support rod, of the grooved connecting plate is rotatably connected to a corresponding one of rotating wheels, wherein one of the rotating wheels abuts against the connecting block, and another of the rotating wheels abuts against a shaft end nut close to the traction tube.

6. The device for detecting and adjusting comprehensive dynamic balance of turbomolecular pump rotors according to claim 2, wherein the detection mechanism comprises a laser detection part fixedly connected in the test platform and vibration detection parts symmetrically arranged at two sides of the supporting mechanism, the laser detection part comprises a second support rod fixedly connected to the test platform, the second support rod is located at one side close to the traction tube, a top surface of the second support rod is connected to a third support rod through a first universal ball joint, a top surface of the third support rod is connected to a clamping component through a second universal ball joint, and the clamping component is internally provided with a laser speed sensor.

7. The device for detecting and adjusting comprehensive dynamic balance of turbomolecular pump rotors according to claim 6, wherein each of the vibration detection parts comprises brackets arranged outside the outer frames, a thin metal rod is fixedly connected to each of the brackets, a vibration sensor is arranged on the thin metal rod, and the vibration sensor is fixedly connected to the bottom surface of the test platform.

8. The device for detecting and adjusting comprehensive dynamic balance of turbomolecular pump rotors according to claim 1, wherein the weight removing mechanism comprises a mobile platform installed at the top of the test platform, a tool holder is installed on the mobile platform, a cutting tool is installed in the tool holder, and the cutting tool is located above the traction tube.

9. The device for detecting and adjusting comprehensive dynamic balance of turbomolecular pump rotors according to claim 1, wherein the driving mechanism comprises a drive box fixedly connected to the bottom of the test platform, a drive motor is installed on one side of the drive box, an output shaft of the drive motor extends into the drive box and is installed with a first gear shaft through a coupling, the first gear shaft is rotatably connected to the drive box, a first gear and a second gear are both fixedly connected to the first gear shaft; a second gear shaft is rotatably connected in the drive box, a third gear and a fourth gear are both fixedly connected to the second gear shaft; the first gear is matched with the third gear, and the second gear is matched with the fourth gear; and a belt pulley is fixedly connected to the second gear shaft, and the belt pulley is in transmission connection with the traction tube through a belt.
